(19) United States
(12) Patent Application Publication
(10) Pub. No.: US 2013/0181111 A1
(43) Pub. Date: Jul. 18, 2013

(54) LIGHT MEASURING CIRCUIT AND METHOD

(71) Applicant: Renesas Electronics Corporation, Kawasaki-shi (JP)

(72) Inventor: Tadashi JAHANA, Kawasaki-shi (JP)

(73) Assignee: Renesas Electronics Corporation, Kawasaki-shi (JP)

(21) Appl. No.: 13/737,813

(22) Filed: Jan. 9, 2013

(30) Foreign Application Priority Data
Jan. 13, 2012 (JP) 2012-004838

(51) Int. Cl. G01J 1/44

(52) U.S. Cl. CPC G01J 1/44
USPC 250/206

(57) ABSTRACT

A light measuring circuit includes an integration circuit for integrating a current supplied form a photoelectric conversion element, an AD converter for AD converting the output voltage of the integration circuit, and a controller for obtaining a first AD conversion result from the AD converter and controlling the integration circuit and the AD converter to determine the time constant of the integration circuit in a second AD conversion following a first AD conversion. In this way, it is possible to measure the photocurrent with a wide dynamic range without making the circuit more complicated.

### CROSS-REFERENCE TO RELATED APPLICATIONS

The disclosure of Japanese Patent Application No. 2012-004838 filed on Jan. 13, 2012 including the specification, drawings and abstract is incorporated herein by reference in its entirety.

### BACKGROUND

The present invention relates to a light measuring circuit and method. More particularly, the present invention relates to a light measuring circuit and method having the function of integrating the current supplied from a photoelectric conversion element.

The current supplied from a photoelectric conversion element is output as a digital signal by using a photoelectric analog/digital converter. There has been known an analog/digital converter including: a capacitance for storing a charge according to the input voltage value to be measured; a constant current circuit for discharging the stored charge; and a counter for counting the clock pulse from the start of the discharge until the voltage between both ends is constant. A problem in this analog/digital converter is that the greater the input voltage to be measured, the longer the time to be required for the discharge of the capacitance, resulting in an increase in the conversion time.

Thus, Patent document 1 (Japanese Unexamined Patent Publication No. 2008-42886) discloses an analog/digital converter that allows for both expansion of the input dynamic range and improvement of the minimum resolution, while being able to reduce measurement time. The analog/digital converter includes a charging circuit having a charge capacitor for storing a charge according to the input current, and first and second discharge circuits for discharging the charge stored in the charge capacitor. Then, the analog/digital converter outputs a digital value according to the amount of charge stored in the charge capacitor. The analog/digital converter charges the charge capacitor for a predetermined charge time, and discharges from the first discharge circuit each time the charge capacitor is charged to a predetermined level of charge. Further, the analog/digital converter discharges from the second discharge circuit after the charge time has passed. In this way, the analog/digital converter outputs the digital value of the voltage according to the amount of charge of the charge capacitor, based on the discharge frequency of the first discharge circuit and on the discharge time of the second discharge circuit.

Further, Patent document 2 (Japanese Unexamined Patent Publication No. Sho 63 (1988)-282622) discloses a photometer including a discharge unit for determining the range of the output of a light measuring unit, and discharging at a current according to the determination result. Thus, the photometer switches the discharge current based on the determination result. With such a photometer, it is possible to reduce the time for the AD conversion of the integral signal to within a predetermined time period, regardless of the integral.

### SUMMARY

The following analysis is given in the present invention.

Photocurrent analog-to-digital converters are used in various electronic devices. In this case, for example, the dynamic range of the illumination reaches 10⁷, or even more, in an environment where the difference in the illumination between inside and outside the place where a mobile phone or other portable electronic device is used is significant. In such an environment, the analog-to-digital converter disclosed in Patent document 1 includes a single charge circuit to charge for a wide input dynamic range, so that the output of the digital value according to the amount of charge has a wide dynamic range. As a result, the output digital value may not have a sufficient accuracy for the wide input dynamic range.

On the other hand, the photometer disclosed in Patent document 2 includes a discharge unit for determining the range of the output of a light measuring unit, and discharging at a current according to the determination result. In this way, the photometer switches the discharge current according to the determination result. With this configuration, the photometer can support a wide dynamic range. However, when it is determined by a comparator that the output of the integrator, which is the output of the light measuring unit, exceeds a criterion, the photometer increases the time constant of the integrator. Thus, in order to support a wider dynamic range, it is necessary to provide a larger number of criteria. In other words, it is necessary to provide many comparators to compare the output of the integrator with the criterion. As a result, the circuit is complicated.

According to one aspect of the present invention, a light measuring circuit includes: an integration circuit for integrating a current supplied from a photoelectric conversion element; an AD converter for AD converting the output voltage of the integration circuit; and a controller for obtaining a first AD conversion result from the AD converter, and controlling the integration circuit and the AD converter to determine the time constant of the integration circuit in a second AD conversion following the first AD conversion based on the value of the first AD conversion result.

Another aspect of the present invention is a method for measuring light received by a photoelectric conversion element by using a circuit. The circuit includes an integration circuit for integrating the current supplied from the photoelectric conversion element, and an AD converter for AD converting the output voltage of the integration circuit. The light measurement method includes the steps of obtaining a first AD conversion result from the AD converter, and determining the time constant of the integration circuit in a second AD conversion following the first AD conversion.

According to the present invention, the time constant of the integration circuit in the second AD conversion following the first AD conversion is determined based on the value of the first AD conversion result. Thus, it is possible to measure the photocurrent with a wide dynamic range, without making the circuit more complicated.

### BRIEF DESCRIPTION OF THE DRAWINGS

FIG. 1 is a circuit diagram of a light measuring circuit according to a first embodiment of the present invention;

FIG. 2 is a flow chart of the operation of the light measuring circuit according to the first embodiment of the present invention;

FIG. 3 is a time chart showing waveforms of the individual components when the photocurrent is small;

FIG. 4 is a time chart showing waveforms of the individual components when the photocurrent is large;

FIG. 5 is a circuit diagram of a light measuring circuit according to a second embodiment of the present invention; and

FIG. 6 is a circuit diagram of a light measuring circuit according to a third embodiment of the present invention.

### DETAILED DESCRIPTION

Hereinafter, the best mode for carrying out the present invention will be described. Note that the reference numerals used in the following description are merely an example for better understanding, and are not intended to limit the illustrated embodiments.

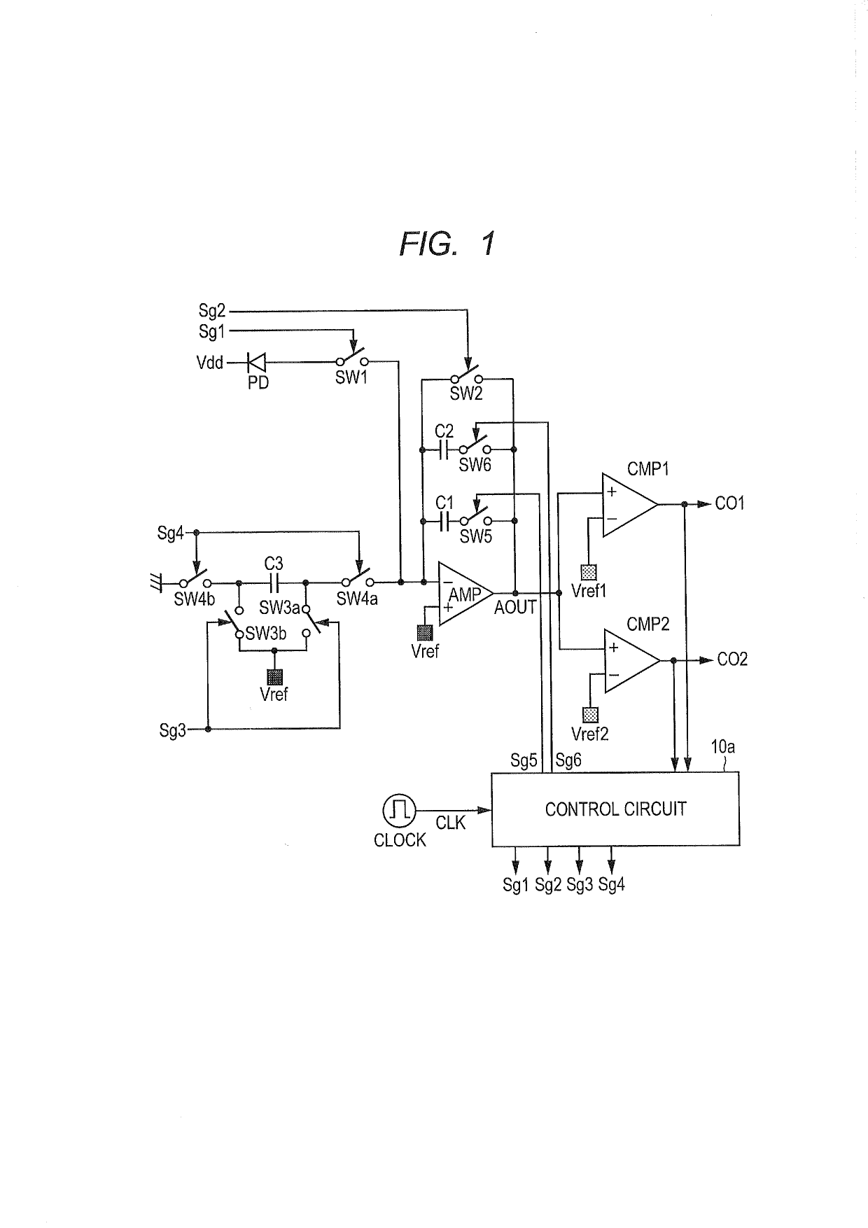

According to a preferred embodiment of the present invention, a light measuring circuit includes: an integration circuit (corresponding to AMP, C1, and C2 in FIG. 1) for integrating a current supplied from a photoelectric conversion element (corresponding to PD in FIG. 1); an AD converter (corresponding to part of the function of CMP1, CMP2, and 10a in FIG. 1) for AD conversion of the output voltage of the integration circuit; and a controller (corresponding to part of the function of 10a in FIG. 1) for obtaining a first AD conversion result from the AD converter, and controlling the integration circuit and the AD converter to determine the time constant of the integration circuit in a second AD conversion following the first AD conversion.

In the light measuring circuit, the controller preferably controls so that the time constant of the integration circuit in the second AD conversion is different from that in the first AD conversion.

In the light measuring circuit, the integration circuit includes an operational amplifier (AMP in FIG. 1) for receiving a current supplied from a photoelectric conversion element to an inverting terminal, coupling a non-inverting terminal to a reference voltage (Vref in FIG. 1), and outputting the output voltage of the integration circuit from an output terminal. Further, the integration circuit also includes first to n-th (n is an integer of 2 or more) capacitive elements that can be coupled in parallel between the non-inverting terminal and the output terminal. It is also possible that the controller determines the time constant of the integration circuit in the second AD conversion based on the number of the coupled capacitive elements, by changing the coupling of the first to n-th capacitive elements according to a first AD conversion result.

In the light measuring circuit, the AD converter can measure the clock number in the period from when the output voltage of the integration circuit passes a first threshold to when the output voltage of the integration circuit passes a second threshold. In this way, the AD converter can output the values of the first and second AD conversion results according to the measured clock number.

In the light measuring circuit, a discharge circuit (corresponding to C3, SW3a, SW3b, SW4a, and SW4b in FIG. 1) is also provided to discharge the charge stored in the integration circuit. The controller can control the discharge circuit to have the discharge time constant according to the determined time constant of the integration circuit.

The semiconductor device can include the photoelectric conversion element as well as the light measuring circuit described above.

The above described light measuring circuit operates so as to determine the time constant of the integration circuit in the second AD conversion time following the first AD conversion based on the value of the first AD conversion result. As a result, it is possible to measure the photocurrent with a wide dynamic range, without making the circuit more complicated.

Hereinafter, preferred embodiments of the present invention will be described with reference to the accompanying drawings.

### First Embodiment

FIG. 1 is a circuit diagram of a light measuring circuit according to a first embodiment of the present invention. In FIG. 1, the light measuring circuit includes a photo diode PD, an amplifier AMP, comparators CMP1 and CMP2, capacitive elements C1, C2, and C3, switches SW1, SW2, SW3a, SW3b, SW4a, SW4b, SW5, and SW6, and a control circuit 10a.

The photo diode PD couples a cathode to a power supply Vdd, and couples an anode to an inverting terminal (−) of the amplifier AMP through the switch SW1. The amplifier AMP couples the switch SW2, a series circuit of the switch SW6 and the capacitive element C2, and a series circuit of the switch SW5 and the capacitive element C1 between the output terminal and the inverting terminal, respectively. Further, the amplifier AMP couples a non-inversion terminal (+) to a reference voltage Vref, to supply an output voltage AOUT from the output terminal to the non-inverting terminals of the comparators CMP1 and CMP2, respectively. However, it is assumed that the capacitance of the capacitive element C2 is greater than the capacitance of the capacitive element C1.

The comparator CMP1 couples the non-inverting terminal to a reference voltage Vref1 (however, Vref1<Vref) and outputs an output signal C01 to the control circuit 10a. The comparator CMP2 couples the non-inverting terminal to a reference voltage Vref2 (however, Vref2<Vref1) and outputs an output signal CO2 to the control circuit 10a. The capacitive element C3 is coupled at an end thereof to the inverting terminal of the amplifier AMP through the switch SW4a, and is also coupled to the reference voltage Vref through the switch SW3a. Further, the capacitive element C3 is coupled at the other end thereof to the ground through the switch SW4b working with the switch SW4a. At the same time, the capacitive element C3 is coupled to the reference voltage Vref through the switch SW3b working with the switch SW3a.

The control circuit 10a includes a microprocessor. The control circuit 10a receives the output signals CO1, CO2 as well as a clock signal CLK, and outputs signals Sg1 to Sg6 that control opening and closing the switches SW1, SW2, SW3a and SW3b, SW4a and SW4b, SW5, and SW6, respectively. Note that when the signal for controlling the opening and closing is H level, the corresponding switch is shorted (ON), while when the signal is L level, the corresponding switch is opened (OFF).

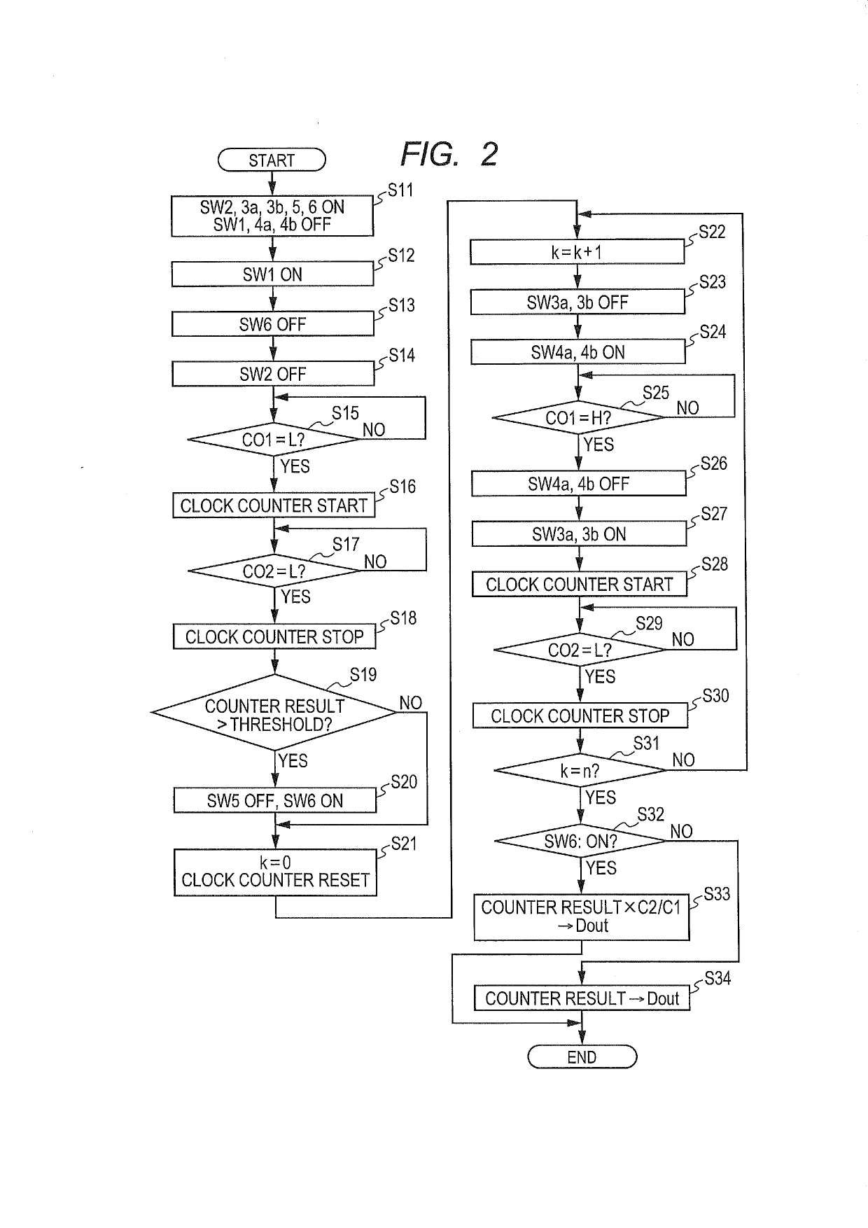

Next, the operation of the control circuit 10a will be described. FIG. 2 is a flow chart of the operation of the light measuring circuit.

In step S11, the switches SW2, SW3a, SW3b, SW5, and SW6 are shorted, while the switches SW1, SW4a, and SW4b are opened. Then, the capacitive elements C1 to C3 discharge the stored charge to initialize the light measuring circuit.

In step S12, the switch SW1 is shorted to supply photocurrent from the photo diode PD to the inverting terminal (−) of the amplifier AMP.

In step S13, the switch SW 6 is opened to only use the capacitive element C1 as the charging circuit.

The above is the process of a halt period T1 in which the integration circuit and discharge circuit are initialized.

In step S14, the switch SW2 is opened between the output terminal and the inverting terminal in the amplifier AMP. In this way, the photocurrent is integrated by the capacitive element C1, and the output voltage AOUT is reduced from the reference voltage Vref.

In step S15, the light measuring circuit waits until the output voltage AOUT is less than the reference voltage Vref1 and the output signal CO1 is changed to L level.

In step S16, the light measuring circuit starts counting the clock signal CLK.

In step S17, the light measuring circuit waits until the output voltage AOUT is less than the reference voltage Vref2 and the output signal CO2 is changed to L level.

In step S18, the light measuring circuit stops counting the clock signal CLK. At this time, the obtained count value of the clock signal CLK corresponds to the first AD conversion result.

In step S19, the light measuring circuit determines whether the count value of the clock signal CLK exceeds a predetermined threshold. If not, the light measuring circuit holds the time constant of the integration circuit, and the process proceeds to step S21.

In step S20, the switch SW5 is opened and the switch SW6 is shorted. In other words, the capacitive element C2 of the integration circuit is selected to increase the time constant of the integration circuit.

As described above, the process of an approximate measurement period T2 is provided before a measurement zone T3 to decide the time constant of the integration in the measurement zone T3. Then, the process in the measurement zone T3 is performed as described below.

In step S21, the light measuring circuit sets a count value k of saw-tooth wave described below to zero. At the same time, the light measuring circuit resets the counter of the clock signal CLK.

In step S22, the light measuring circuit sets k=k+1.

In step S23, the switches SW3a and SW3b are opened.

In step S24, the switches SW4a and SW4b are shorted to couple the capacitive element C3 of the discharge circuit between the inverting terminal of the amplifier AMP and the ground. In this way, the electric charge charged by the capacitive element C1 or C2 is discharged through the capacitive element C3. As a result, the output voltage AOUT increases.

In steps S25, the light measuring circuit waits until the output voltage AOUT exceeds the reference voltage Vref1 and the output signal CO1 is changed to H level.

In step S26, the switches SW4a and SW4b are opened to disconnect the discharge circuit.

In step S27, the switches SW3a and SW3b are shorted to set the potential to Vref at the two ends of the capacitive element C3 of the discharge circuit.

In step S28, the light measuring circuit starts counting the clock signal CLK.

In step 29, the light measuring circuit waits until the output voltage AOUT is less than the reference voltage Vref2 and the output signal is changed to L level.

In step S30, the light measuring circuit stops counting the clock signal CLK.

In step S31, the light measuring circuit determines whether the count value k of the saw-tooth wave reaches a predetermined value n. If not, the process returns to step S22. When the count value k reaches the predetermined value n, the process proceeds to step S32.

In step S32, the light measuring circuit determines whether the switch SW6 is shorted. In other words, the light measuring circuit determines whether the switch with a larger time constant of the integration circuit is selected. When the switch SW6 is shorted, in step S33, the light measuring circuit multiplies the count of the clock signal CLK by C2/C1 to obtain an AD conversion result Dout. Further, when the switch SW6 is opened, in step S34, the light measuring circuit obtains the AD conversion result Dout from the count of the clock signal CLK.

The light measuring circuit operates as described above. In the light measuring circuit, the approximate measurement period T2 is provided before the capacitive element C1 of the integration circuit. Then, in the approximate measurement period T2, the charge of the photocurrent generated in the photo diode PD is stored in the capacitive element C1 of the integration circuit. Due to the storage of the charge, the output voltage AOUT is reduced from the maximum value Vref1, and the output signal C01 is changed to L level. Then, when the output voltage AOUT is less than the minimum value Vref2, the output signal CO2 is changed to L level. The light measuring circuit determines the general illumination by counting the number of clock signals CLK in the period from when the output signal CO1 is changed to L level to when the output signal CO2 is changed to L level. In other words, the light measuring circuit determines the general illumination is low when the count number of the clock signal CLK is greater than the predetermined threshold. Then, the light measuring circuit reduces the time constant of the integration circuit in the measurement zone T3. On the other hand, the light measuring circuit determines the general illumination is high when the count number of the clock signal CLK is equal to or less than the predetermined threshold. Then, the light measuring circuit increases the time constant of the integration circuit in the measurement zone T3.

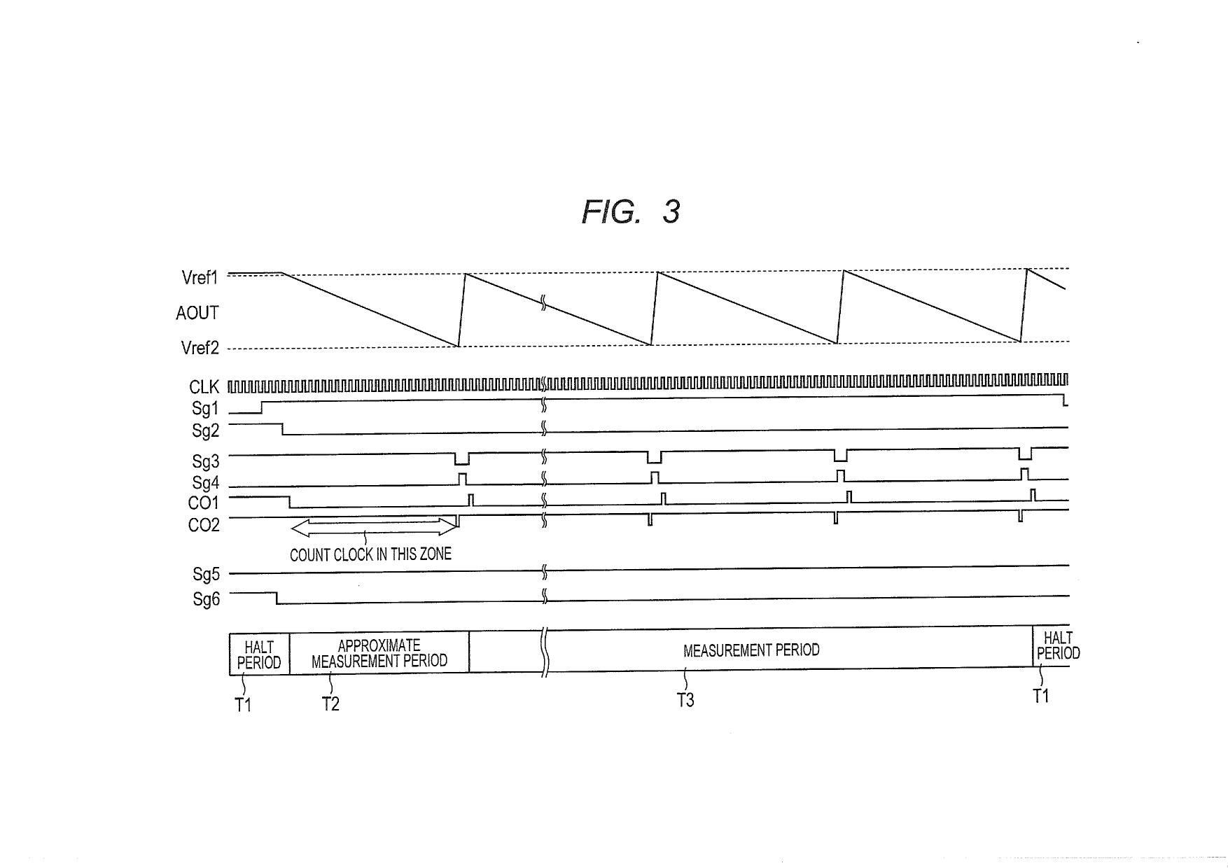

FIG. 3 is a time chart showing waveforms of the individual components when the photocurrent is small, in which the count number from when the output signal CO1 is changed to L level, to when the output signal CO2 is changed to L level is greater than a certain count number (for example, corresponding to 3000 Lux to 5000 Lux). When the general illumination in the approximate measurement period T2 is low, the light measuring circuit sets the signal Sg6 to L level (turning off SW6), and sets the signal Sg5 to H level (turning on SW5). Then, the light measuring circuit uses the high resolution capacitive element C1 in the measurement zone T3.

After the resolution is determined, the light measuring circuit discharges the charge stored in the capacitive element C1 of the integration circuit by the operation of the discharge circuit. Then, the light measuring circuit sets the output of the integration circuit to Vref, and starts the illumination measurement. At this time, in order to measure the illumination, the light measuring circuit counts n times the number of saw-tooth waves in the output voltage AOUT output from the integration circuit in the measurement zone. In this way, the light measuring circuit obtains the value of the illumination.

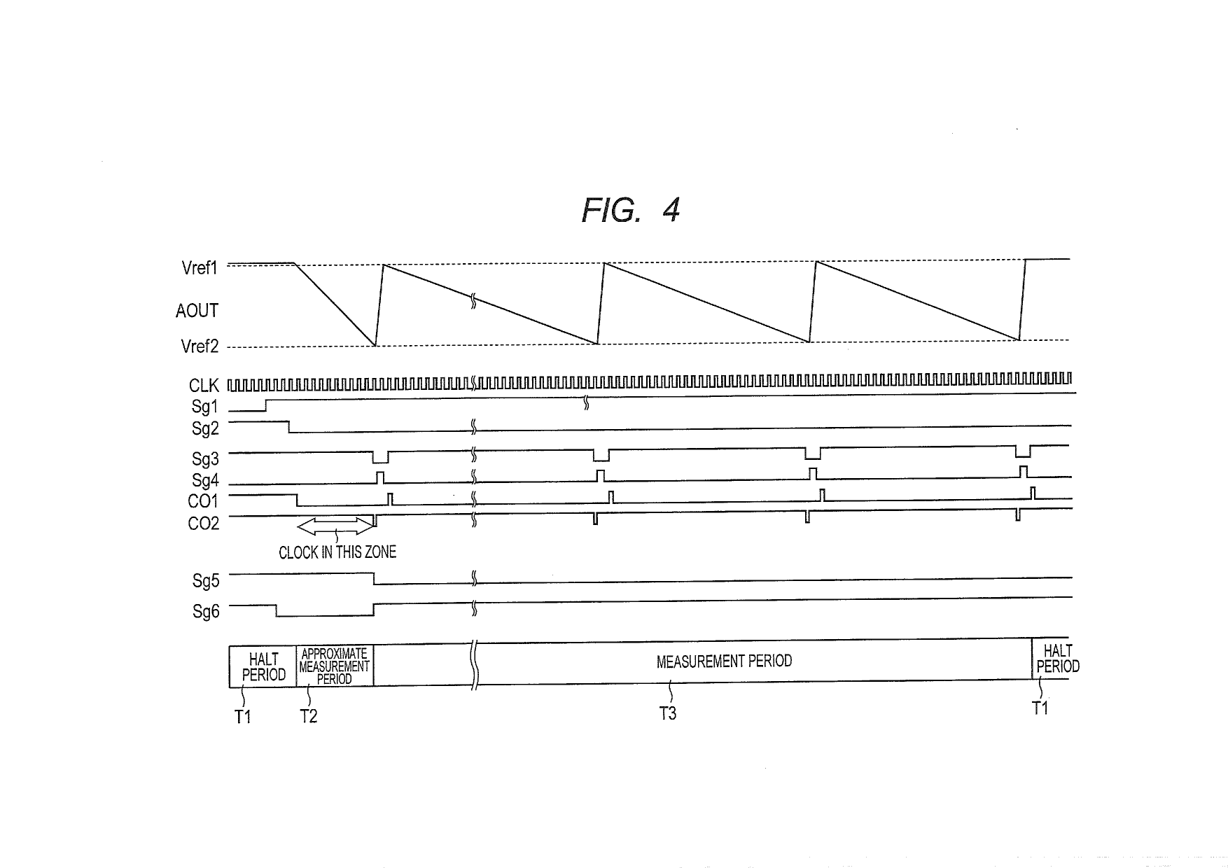

FIG. 4 is a time chart showing waveforms of the individual components when the photocurrent is large, in which the count number of clock from when the output signal Co1 is changed to L level, to when the output signal CO2 is changed to L level is smaller than a certain count value (corresponding to 3000 Lux to 5000 Lux). When the general illumination in the approximate measurement period T2 is high, the light measuring circuit sets the signal Sg6 to H level (turning on SW6), and sets the signal Sg5 to L level (turning off SW5). Then, the light measuring circuit uses the high resolution capacitive element C2 in the measurement zone T3. The capacitance is set to C2>C1, so that the time constant of the integration is large. The virtual slope is more moderate when C2 is used than when C1 is used. (Actually, the photocurrent is large, so that the slope itself is not moderated). When C2 is used, the measured number of saw-tooth waves is multiplied by C2/C1 as the value of the illumination.

With the light measuring circuit described above, it is possible to change the resolution by switching the coupling between the two capacitive elements C1, C2 according to the value of the first AD conversion result. This makes it possible to measure the photocurrent as the second AD conversion result with respect to both large and small illuminations for a short time. In other words, it is possible to measure the photocurrent with a wide dynamic range by changing the time constant of the integration circuit according to the value of the first AD conversion result.

### Second Embodiment

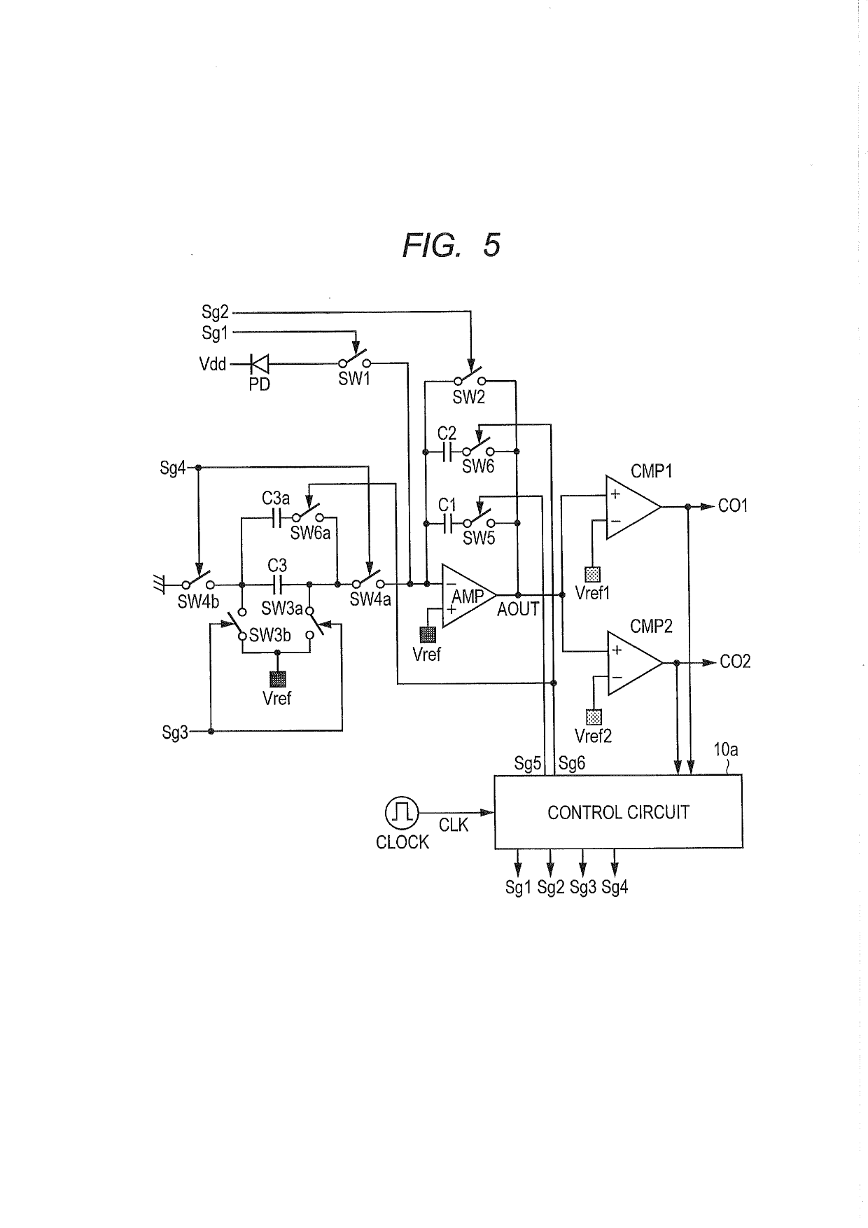

FIG. 5 is a circuit diagram of a light measuring circuit according to a second embodiment of the present invention. The same reference numerals as in FIG. 1 denote the same parts in FIG. 5, and the detailed description thereof will be omitted. The configuration of the measuring circuit in FIG. 5 is the same as the configuration in FIG. 1. However, in FIG. 5, a series circuit of a switch SW6a and a capacitive element C3a is further coupled to the capacitive element C3 in parallel. The opening and closing of the switch SW6a is controlled by the signal Sg6 output from the control circuit 10a.

The measuring circuit with this configuration has a discharge circuit including two capacitive elements C3 and C3a. When it is determined that the general illumination is high in the approximate measurement period, the measuring circuit closes the switches SW6 and SW6a. In other words, when the general illumination is high, the measuring circuit increases the charging time constant in the measurement zone, and also increases the discharging time constant.

In the case of the first embodiment, the time for discharging the charge stored in C2 is C2/C1 times the time for discharging the charge stored in C1. On the other hand, it is possible to reduce the discharging time by C3/(C3+C3a) times by adding the capacitive element C3a for the discharge that can be switched as shown in FIG. 5.

### Third Embodiment

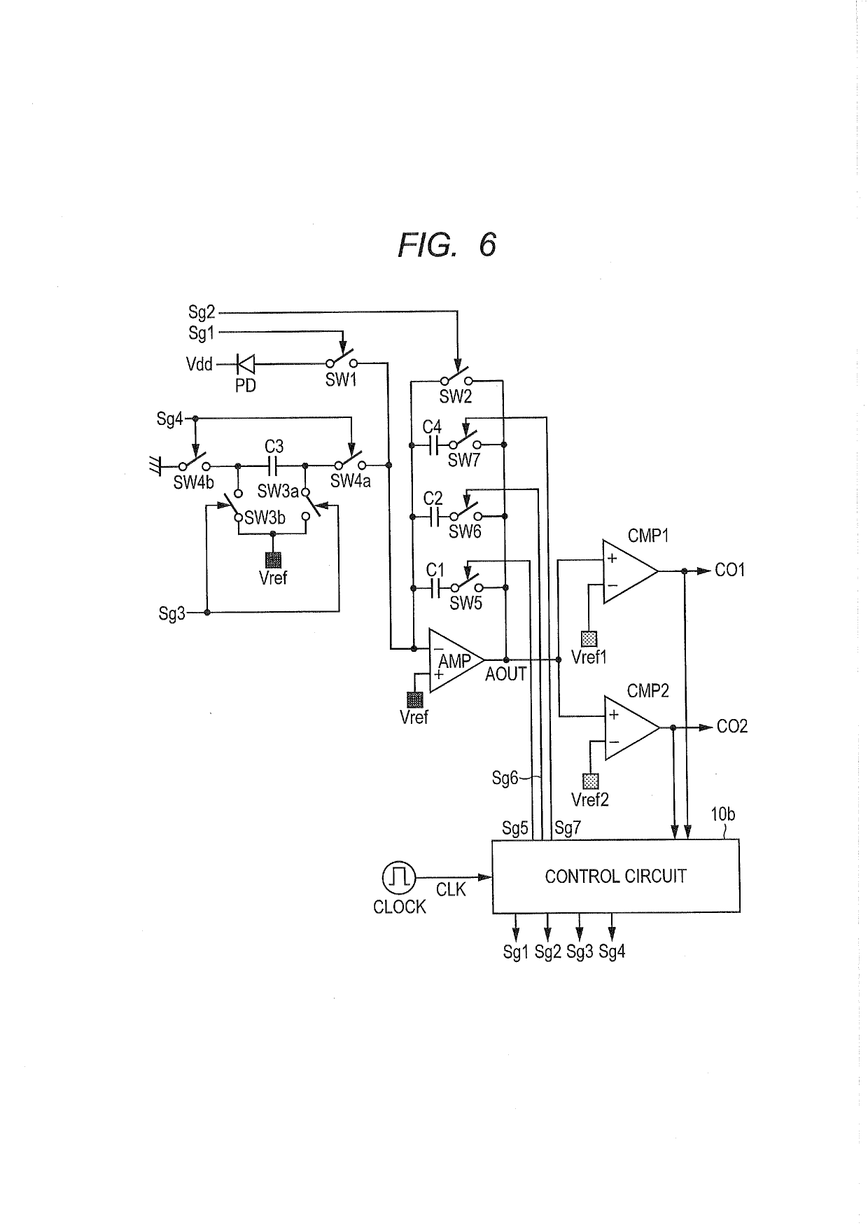

FIG. 6 is a circuit diagram of a light measuring circuit according to a third embodiment of the present invention. The same reference numerals as in FIG. 1 denote the same parts in FIG. 6, and the detailed description thereof will be omitted. The configuration of the measuring circuit in FIG. 6 is the same as the configuration in FIG. 1. However, in FIG. 6, a series circuit of a switch SW7 and a capacitive element C4 is further coupled between the output terminal and the inverting terminal in the amplifier AMP. A control circuit 10b has the same function as that of the control circuit 10a in FIG. 1. In addition, the control circuit 10b also has the function of outputting a signal Sg7 to control the opening and closing of the switch SW7.

In the light measuring circuit with this configuration, the integration circuit has a plurality of capacitive elements (here, C1, C2, and C4) to convert the photocurrent generated in the photo diode PD to a voltage. In other words, the measuring circuit includes the three capacitive elements, C1, C2, and C4 in the integration circuit, and can support seven resolutions according to the combination of the capacitive elements. For example, it is assumed that the capacitance of the capacitive elements are set to C2=kC1 and C4=mC1, and that the resolution in the C1 coupling is 1 lux (the charge generated by irradiating the PD with a light of 1 lux is equal to the capacitance of C1). In this case, seven stages of resolution can be obtained: 1, k, m, 1+k, 1+m, m+k, and 1+m+k.

Further, more precise switching control of the resolution can be achieved by providing four or more capacitive elements. In general, 2ⁿ-1 stages of resolution can be achieved by providing n types of capacitive elements and providing switches corresponding to the particular capacitive elements.

Note that here the circuit using only C3 is exemplified as the discharge circuit. However, it is also possible to increase the number of capacitive elements of the discharge circuit according to the number of capacitive elements of the integration circuit. In this case, it is possible to prevent the discharge time from increasing due to the increase in the number of capacitive elements of the integration circuit.

With the light measuring circuit described above, it is possible to determine the range of the photocurrent generated by the photo diode PD in the approximate measurement period, and change the time constant of the integration circuit into n (n=3 in the example above) types in the measurement zone according to the determination result. In other words, it is possible to change the stage of the resolution into n types. Thus, it is possible to measure the photocurrent with a wide dynamic range without making the circuit more complicated.

The light measuring circuit and method according to the present invention can be applied to illuminance sensors, lighting systems, and electronic devices.

The disclosures of Patent documents 1 and 2 are hereby incorporated into the present disclosure by reference. Further, modifications of the exemplary embodiments can be made within the scope of the overall disclosure (including the claims) of the present invention and based on the basic technical concept of the present invention. Furthermore, various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept.

What is claimed is:

1. A light measuring circuit comprising:
an integration circuit for integrating a current supplied from a photoelectric conversion element;
an AD converter for AD converting the output voltage of the integration circuit; and
a controller for obtaining a first AD conversion result from the AD converter, and controlling the integration circuit and the AD converter to determine the time constant of the integration circuit in a second AD conversion following a first AD conversion based on the value of the first AD conversion result.

2. The light measuring circuit according to claim 1,
wherein the controller controls so that the time constant of the integration circuit in the second AD conversion is different from that in the first AD conversion.

3. The light measuring circuit according to claim 1,
wherein the integration circuit comprises:
an operational amplifier for receiving a current that is supplied from the photoelectric conversion element to an inverting terminal, coupling a non-inverting terminal to a reference voltage, and outputting the output voltage of the integration circuit from an output terminal; and
first to n-th (n is an integer of 2 or more) capacitive elements that can be coupled in parallel between the non-inverting terminal and the output terminal,
wherein the controller determines the time constant of the integration circuit in the second AD conversion according to the number of the coupled capacitive elements, by changing the coupling of the first to n-th capacitive elements based on the first AD conversion results.

4. The light measuring circuit according to claim 1,
wherein the AD converter measures the clock number in the period from when the output voltage of the integration circuit passes a first threshold to when the output voltage of the integration circuit passes a second threshold,
wherein the AD converter outputs the values of the first and second AD conversion results corresponding to the measured clock number.

5. The light measuring circuit according to claim 1, further comprising:
a discharge circuit for discharging the charge stored in the integration circuit,
wherein the controller controls the discharge circuit to have the time constant according to the determined time constant of the integration circuit.

6. A semiconductor device comprising the photoelectric conversion element as well as the light measuring circuit according to claim 1.

7. A method for measuring light received by a photoelectric element by using a circuit, the circuit including: an integration circuit for integrating a current supplied form the photoelectric conversion element; and an AD converter for AD converting the output voltage of the integration circuit,
the method comprising:
obtaining a first AD conversion result from the AD converter; and
determining the time constant of the integration circuit in a second AD conversion following a first AD conversion based on the first AD conversion result.
